(19) United States
(12) Patent Application Publication
(10) Pub. No.: US 2016/0070822 A1
(43) Pub. Date: Mar. 10, 2016

(54) Method, Apparatus and Computer Program Code for Design and Visualization of a Physical Object

(71) Applicant: Primesmith Oy, Oulu (FI)

(72) Inventors: Marko Makinen, Oulu (FI); Juha-Heikki Kantola, Oulu (FI); Jani Lehtinen, Oulunsalo (FI); Jesse Kuhn, Helsinki (FI); Kristian Saarikorpi, Fiskars (FI); Jussi Saarelainen, Helsinki (FI)

(73) Assignee: Primesmith Oy, Oulu (FI)

(21) Appl. No.: 14/481,095

(22) Filed: Sep. 9, 2014

(51) Int. Cl. G06F 17/50; G05B 19/4097

(52) U.S. Cl. CPC G06F 17/50; G05B 19/4097; G05B 2219/35134

(57) ABSTRACT

The invention relates to a method, an apparatus and a computer program code for design and visualization of a physical object. The method, the computer program code and the apparatus present a consumer friendly approach for modelling a physical object that can be manufactured without requiring skills to use and knowledge of CAD tools and designer programs or understanding principles of 3D modelling and picture data rendering, for example, that would be beyond knowledge and skills of an average consumer or reachable for the average consumer.

### TECHNICAL FIELD OF THE INVENTION

The invention relates to a method for design and visualization of a physical object. The invention also relates a non-transitory computer readable storage medium having computer-executable components for design and visualization of a physical object. The invention relates also to an apparatus with integrated camera for design and visualization of a physical object.

### BACKGROUND OF THE INVENTION

Solutions relating to embedding a photograph or other such picture to physical objects such as pendants, other type of jewelry, key rings and integrated photo frames, for example, are common. In these solutions a consumer's own picture is embedded as is into an object of choice. Varying Internet based services for ordering such objects customized with a personal picture are also common.

Computer Aided Design (CAD) tools and varying designer computer program products are also commonly known in the art. They are tools intended for professionals such as engineers or designers for complex design and modelling of wide range of subjects from design artefacts to works of engineering. Computer Aided Design (CAD) tools and varying designer computer program products are not easily available for average consumers either. They also require relatively extensive training before anyone is capable to use them.

Recently software applications for three dimensional (3D) object modelling have also been developing. In these software applications integrated camera of a mobile device, such as a tablet or a mobile phone, for example, is utilized to capture the dimensions of an object to be modelled. A user of such software application is required to circle the camera view around the object to be modelled in order to capture a 3D-view of the object as is, for example. These software applications aim to digitize as 1:1 realistic copy of the object to be modelled as possible in order to enable 3D-printing of a copy of the object. Another known use of relative similar software applications is to model varying spaces for virtual design of interiors, for example.

One of the problems with the present solutions relates to average consumers limited capability to perceive and express 3D shapes, sizes and their possible limitations that relate to reproducing them. This problem is apparent with CAD tools and designer programs as well as with software applications for 3D object modelling that are based on circling the camera view as presented above. All these require relatively good capability to perceive and express also 3D forms of objects. For an average consumer they provide only very limited support for quick and easy two dimensional (2D) visualization of physical objects, which are three dimensional by nature.

The second problem in the art relates to the firstly presented simple solutions in which a photo or other picture, for example, is embedded to a physical object. These photo embedding solutions only enable very limited variation, customization of the final object that would be delivered to a consumer. These solutions lack capability to visualize the finalized object as it would be manufactured. Their level of free choices and personalization according to consumer's needs and wishes are also narrow.

The third problem relates to complexity of CAD tools and designer programs. From the point of view of an average consumer as a user effective use of CAD tools and designer programs require training and knowledge that they do not have. For example, understanding in general these type of tools work, how objects are modelled or how picture data can be rendered is beyond the knowledge and skills of average con25 sumer. Also, CAD tools and designer programs are relatively expensive and therefore mostly intended for professional or at least semi-professional purposes.

In order to solve these problems, a solution for consumer friendly two dimensional (2D) visualization and design of 3D objects is needed.

### SUMMARY OF SOME EXAMPLES OF THE INVENTION

The object of the present invention is to provide a method, a computer program code and an apparatus for design and visualization of a physical object wherein the method, the computer program code and the apparatus present a consumer friendly approach for modelling a physical object that can be manufactured without requiring skills to use and knowledge of CAD tools and designer programs or understanding principles of 3D modelling and picture data rendering, for example.

Further, the object of the present invention is to provide a method, a computer program code and an apparatus for design and visualization of a physical object wherein the method, the computer program code and the apparatus provide a solution that allows consumers to create manufacturing ready physical objects, for example varying types of jewelry and accessories, with variable set of qualities for such an object. The variable set of qualities for the physical object, the attributes for the physical object being modelled, may comprise, for example, a shape of the object, dimensions of the object (height, width, length), texture, finish, embedding, material of object and a method of manufacturing of the object. Also, there can more attributes for the physical object being modelled. The attributes for the physical object being modelled can be selected from a set of predefined options. At least some of the attributes for the physical object being modelled, for example the shape of the object or the dimensions of the object, can also be defined by a user. Also, at least some of the attributes for the physical object being modelled, for example the shape of the object, may also be based on one or more captured images by the user.

Finally, the object of the present invention is to provide a method, a computer program code and an apparatus for design and visualization of a physical object wherein the method, the computer program code and the apparatus provide an easy-to-use approach for an average consumer level user to model and perceive 3D shapes on the basis of 2D images by viewing them from one angle of view at a time.

The objects of the present invention are fulfilled by providing a method for design and visualization of a physical object, the method comprising the steps of:
providing a selection of object attributes for the physical object being modelled on an application user interface;
configuring a mask area of a viewfinder of a camera component to the application user interface according to a selected set of object attributes for the physical object being modelled;
viewing an approximation of the physical object being modelled in the mask area of the configured viewfinder on the application user interface according to the selected set of object attributes;
constructing at least one manufacturing file for the physical object being modelled after at least one image for the physical object being modelled is being captured; and
visualizing the physical object being modelled on the application user interface.

Also, the objects of the present invention are fulfilled by providing a non-transitory computer readable storage medium having computer-executable components for design and visualization of a physical object, the computer-executable components comprising:
a computer readable code for providing a selection of object attributes for the physical object on an application user interface;
a computer readable code for configuring a mask area of a viewfinder of a camera component to the application user interface according to a selected set of object attributes for the physical object being modelled;
a computer readable code for viewing an approximation of the physical object being modelled in the mask area of the configured viewfinder on the application user interface according to the selected set of object attributes;
a computer readable code for constructing at least one manufacturing file for the physical object being modelled after at least one image for the physical object being modelled is being captured; and
a computer readable code for visualizing the physical object being modelled on the application user interface.

Finally, the objects of the present invention are fulfilled by providing an apparatus with integrated camera for design and visualization of a physical object, the apparatus comprising:
a data communication interface;
a one or more processors;
a one or more memories including a computer program code;
a camera component including a camera interface and a viewfinder;
an application user interface; and
the one or more memories and the computer program code configured to, with the one or more processors, cause the apparatus at least to
   receive one or more object attributes for a physical object being modelled from an application user interface;
   configure a mask area of the viewfinder of the camera component by the one or more object attributes for the physical object being modelled; and
   run the viewfinder with the mask area configured according to the one or more object attributes on the application user interface for viewing an approximation of a physical object being modelled.

Some advantageous embodiments of the invention are presented in the dependent claims.

The basic idea of the invention is the following:

Modelling a physical object is performed by a computer program code that advantageously creates a 3D visualization of the physical object being modelled on the basis of one or more 2D images. The computer program code is implemented according to the invention. Advantageously, the computer program code modifies a viewfinder of a camera component of an apparatus on which the computer program code is running according to at least one of the following: data from the camera module and a selected set of object attributes for the physical object being modelled. The set of object attributes is selected on an application user interface implemented with computer program code. Advantageously, the application user interface is a graphical user interface. The result of modification of the viewfinder of the camera component is a configured mask area of a viewfinder that runs on the application user interface.

While the configured mask area of the viewfinder is active, an approximation of the physical object being modelled is advantageously presented in the mask area on the application user interface from one angle of view at a time. The approximation of the physical object being modelled means that while the configured mask area of the viewfinder is running on the application user interface, the viewed image data within the mask area, before capturing an image, is rendered according to the selected set of object attributes for the physical object to be created. The image data viewed within the configured mask area is not 1:1 match with reality. Instead, the viewed image data is advantageously modified to meet the requirements of creating a physical object on the basis of the selected set of attributes for the physical object being modelled with the viewed image data in the mask area. The outlying area of the viewfinder, the area outside the configured mask area of the viewfinder, is unmodified. The outlying area of the viewfinder presents visual data like a regular camera viewfinder does.

After at least one image is captured, a visualization of the physical object being modelled is advantageously presented on the application user interface. Advantageously, the visualization of the physical object being modelled is a presentation of the physical object as it would look like when actually manufactured on the basis of the captured image and the selected set of attributes for the object.

Further by the present invention, after at least one image is captured for the physical object being modelled, a manufacturing file for the physical object being modelled is advantageously created by the computer program code according to the captured image data and the set of selected attributes for the physical object being modelled. Advantageously, the computer program code enables verification of manufacturing capability for the manufacturing file. This means that if the selected set of object attributes comprises a manufacturing method, the computer code program compares the created manufacturing file with parameters of the chosen manufacturing method. Advantageously, the computer code program analyses if the physical object being modelled according to the manufacturing file can be manufactured with the chosen manufacturing method and what is known from that method. Advantageously, the computer program code may also perform a strength calculation for the physical object being modelled on the basis of the manufacturing file to further verify the manufacturing capability of the object.

An advantage of the present invention is that the present invention makes possible to consumer level users to model physical objects by utilizing a camera and without knowledge and skills of CAD or designer tools with the aid of a method, an apparatus and a computer program code according to the invention. Also an advantage of the present invention is that the apparatus, the method and the computer program code according to the invention enable even consumer level users to model physical objects three dimensionally without knowledge and skills of image rendering and 3D modelling. Further, an advantage of the present invention is that it allows users easily try different variations of their desired objects and models desired objects on the basis of user selected attributes. Moreover, an advantage of the present invention is that it is possible to verify if the physical object being modelled can also be manufactured with its chosen manufacturing method and other selected attributes for the object and its durability in its intended use.

Further scope of applicability of the present invention will become apparent from the detailed description given hereafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and accompanying drawings which are given by way of illustration only, and thus are not limitative of the present invention and wherein

FIG. 1 shows the main parts of an apparatus with an integrated camera component and other components.

FIG. 2 shows as an exemplary flow chart of the main steps of the method for design and visualization of a physical object.

FIG. 3 shows as another exemplary flow chart of method for design and visualization of a physical object.

FIG. 4 shows the third exemplary flow chart of method for design and visualization of a physical object.

### DETAILED DESCRIPTION

In the following description, considered embodiments are merely exemplary, and one skilled in the art may find other ways to implement the invention. Although the specification may refer to “an”, “one; or “some” embodiment(s) in several locations, this does not necessarily mean that each such reference is made to the same embodiment(s) or that the feature only applies to a single embodiment. Single feature of different embodiments may also be combined to provide other embodiments.

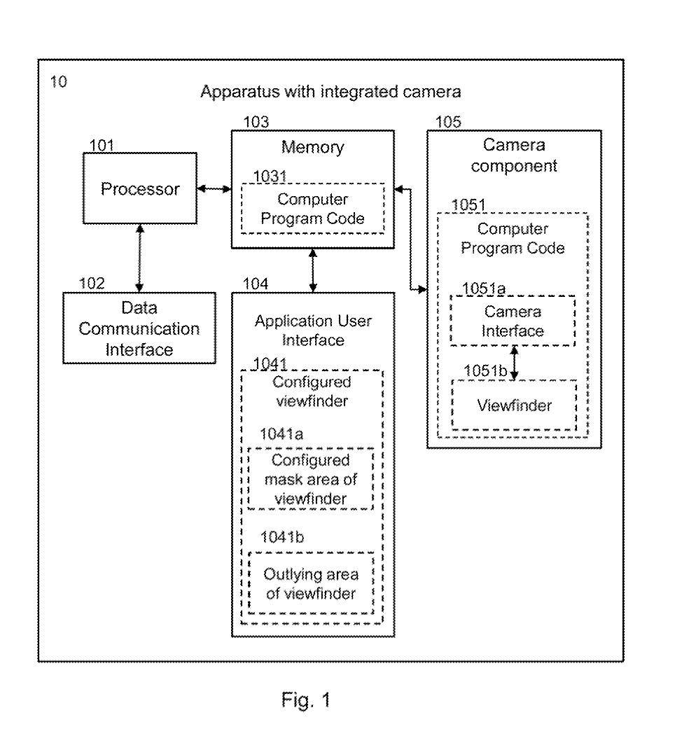

FIG. 1 shows, by way of an example, the main parts of an apparatus with an integrated camera for design and visualization of a physical object. The apparatus with the integrated camera 10 can be, by way of an example, a tablet device, a mobile phone or other such mobile device, a camera device or another similar device suitable also for personal use. The apparatus with the integrated camera 10 comprises of at least one processor 101, at least one data communication interface 102, at least one memory 103, at least one application user interface 104 with a configured viewfinder 1041 and at least one camera component 105. The at least one data communication interface 102 enables the apparatus to communicate with other devices and data networks, for example.

The at least one memory 103 further comprises computer program code 1031 for design and visualization of the physical object. The at least one application user interface further comprises a configured viewfinder 1041 with a configured mask area of the viewfinder 1041a and an outlying area of the viewfinder 1041b. Finally, the at least one camera component 105 further comprises computer program code 1051 for the camera with at least one camera interface 1051a and a viewfinder of the camera 1051b. The camera component 105 with the at least one camera interface 1051a and the viewfinder of the camera component 1051b are responsible delivering basic visual data, a visual data feed, that is visible on the viewfinder 1041 on the application user interface 104.

The computer program code for design and visualization of the physical object 1031 implements the functionality of the application user interface 104. Further, the computer program code for design and visualization of the physical object 1031 accesses the camera component 105 through the camera interface 1051. The computer program code for design and visualization of the physical object 1031 implements the configured viewfinder 1041 by modifying the viewfinder of the camera component 1051b.

The outlying area of the viewfinder 1041b displays a regular viewfinder feed coming from the camera viewfinder 1051b according to the implementation of camera component 105 and the viewfinder of the camera component 1051b. The configured mask area of the viewfinder 1041a is separated from the outlying area of the viewfinder 1041b by the borders of the configured mask area of the viewfinder 1041a. The borders of the configured mask area of the viewfinder 1041a may present a shape of the physical object being modelled. The configured mask area of the viewfinder 1041a displays an effected visual feed of image data based on defined approximation attributes, which mean a selected set of attributes for the physical object being modeled. The visual transition from the outlying area of the viewfinder 1041b to the configured mask area of the viewfinder 1041a is seamless. The configured mask area of the viewfinder 1041a on the application user interface 104 approximates the physical object being modeled according to its selected set of attributes. The selected set of attributes comprises at least one of the following: a shape, dimensions of the object, color, material, texture and manufacturing met. The configured mask area of the viewfinder 1041a simulates a complete physical item based on the selected set of attributes for the physical object being modeled.

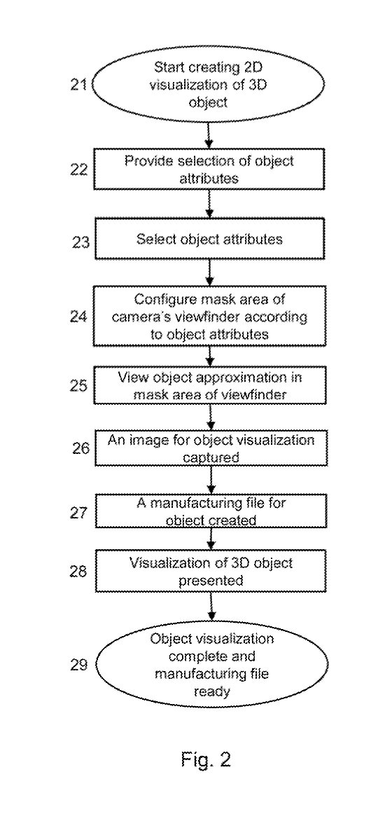

The main steps of the method according to the invention are shown as an exemplary flow chart in FIG. 2. In this advantageous embodiment of the invention, the process creating a design and visualization of a physical object starts in step 21 in which a user starts the application user interface 104 on a suitable apparatus with integrated camera 10. In step 22 a selection of available object attributes for the physical object being modeled are provided on the application user interface 104. Advantageously, the selection of attributes for the physical object being modelled may comprise at least one of the following: a shape of the object, dimensions of the object comprising at least one of the following height, width, and length, texture, colour, a material of object and a method of manufacturing of the object. The user selects the attributes for the physical object being modelled in step 23 through the application user interface 104. The selection of attributes for the physical object being modelled can be predefined by the computer program code 1031. Advantageously, the selection of attributes for the physical object being modelled can be defined by the user on the application user interface 104. For example, the size of the object can be based on its real size on 1:1 scale. Also, the size of the object can be defined by the user. The selection of attributes for the physical object being modelled can also comprise both predefined and user-defined attributes.

In step 24 the set of selected attributes for the physical object being modelled are applied in configuring the mask area of the viewfinder of the camera component 1051b. During step 24 the computer program code for design and visualization of the physical object 1031 accesses the camera component 105 through the camera interface 1051. The computer program code for design and visualization of the physical object 1031 implements the configured mask area of the viewfinder 1041a on the application user interface 104 by modifying the viewfinder of the camera component 1051b according to the set of selected attributes for the physical object being modelled. The configured viewfinder 1041 with the now configured mask area of the viewfinder 1041a is started on the application user interface 104. The outlying area of the viewfinder 1041b displays regular viewfinder feed coming from the camera viewfinder 1051b. In other words, the visible content of the outlying area of the viewfinder 1041b on the application user interface 104 is not modified according to the set of selected attributes for the physical object being modelled.

In step 25 the configured mask area of the viewfinder 1041a is running on the application user interface 104. The configured mask area of the viewfinder 1041a advantageously displays an approximation of the physical object being modeled on the application user interface 104 while the user is searching an image to be captured for creating the model for the physical object. The configured mask area of the viewfinder 1041a displays an effected visual feed of image data based on the defined approximation attributes, which mean the selected set of attributes for the physical object being modeled. The configured mask area of the viewfinder 1041a on the application user interface 104 approximates the physical object being modeled according to its selected set of attributes. Advantageously, viewing an approximation of the physical object being modelled in the mask area of the configured viewfinder 1041a on the application user interface 104 is accomplished by viewing the approximation of the physical object being modelled from one angle of view at a time. A visual transition from the outlying area of the viewfinder 1041b to the configured mask area of the viewfinder 1041a is seamless. Advantageously, the visual transition from the outlying area of the viewfinder 1041b to the configured mask area of the viewfinder 1041a is seamless while the user shifts the viewfinder 1041 from one angle of view to another one. What the user sees in the configured mask area of the viewfinder 1041a on the application user interface 104 is a real-time simulation of what the physical object being modeled would look like with the image content that is inside mask area of the viewfinder 1041a. Also, what the user sees in the configured mask area of the viewfinder 1041a on the application user interface 104 is a semi-finalized simulation of what the physical object being modeled would look like with the image content that is inside mask area of the viewfinder 1041a. The image content that is inside the configured mask area of the viewfinder 1041a is also effected by the selected set of attributes for the physical object being modeled. Further, visual data, the visual feed, coming from the camera component 105 and inside the configured mask area of the viewfinder 1041a can be heavily effected and, for example, a kaleidoscope type of effect can be applied. Also, a visual element can be copied to effect the visual data coming from the camera component 105, for example. This means applying effects to the visual feed from the camera component regardless of other the selected set of attributes for the physical object being modeled that modifies the image data in the inside of the configured mask area of the viewfinder 1041a. The visual data from the camera component 105 can also be effected prior to embedding it into a design of the physical object being modeled with effecting based on aesthetic values. This effecting can also extend to the outlying of the viewfinder 1041b.

At least one image for creating a visualization of the physical object being modeled is captured in step 26 by the user. Advantageously, the captured image is a regular 2D image. More advantageously, the visual data for the image can also be based on multiple layers of visual data coming from multiple images. Pressing the shutter button of the used apparatus with integrated camera 10 captures the image data as visualized within the configured mask area of the viewfinder 1041a. The image is captured and stored according to the implementation of the camera component present in the used apparatus 10 in which the application user interface 104 is running.

A manufacturing file for the physical object being modeled is created in step 27 by the computer program code 1031. The manufacturing file comprises the set of selected attributes for the physical object being modeled together with the image data for physical object captured in step 26. While constructing the manufacturing file the captured image is embedded to the design of the physical object modeled. Advantageously, embedding the captured image to the design of the physical object modeled is defined by the selected set of attributes for the physical object modeled. The manufacturing file is stored in a suitable area of the memory 103. Advantageously, the manufacturing file is a standard 3D file. The manufacturing file is a standard 3D file suitable for producing the physical object with various devices and systems recognizing such a file.

A visualization for the physical object being modeled is presented on the application user interface 104 according to step 28. The visualization for the physical object being modeled is created by the computer program code 1031 according to the manufacturing file. Advantageously, the visualization of the physical object being modelled is a presentation of the physical object as it would look like when actually manufactured on the basis of the captured image and the selected set of attributes for the object. The visualization of the physical object being modelled is a presentation of the physical object as it would appear when manufactured according to the created manufacturing file. More advantageously, the visualization of the physical object being modelled is a 3D visualization. The 3D visualization may be created by the computer program code 1031 by viewing the physical object being modelled on the basis of 2D images from one angle of view at a time.

The process of design and visualization of the physical object is completed in step 29. The manufacturing file for the physical object is ready according to step 27. Advantageously, on the application user interface 104, there may be an option to retrieve the manufacturing file from the memory 103, for example. Also advantageously, on the application user interface 104, there may be an option to order a product according to the manufacturing file, for example.

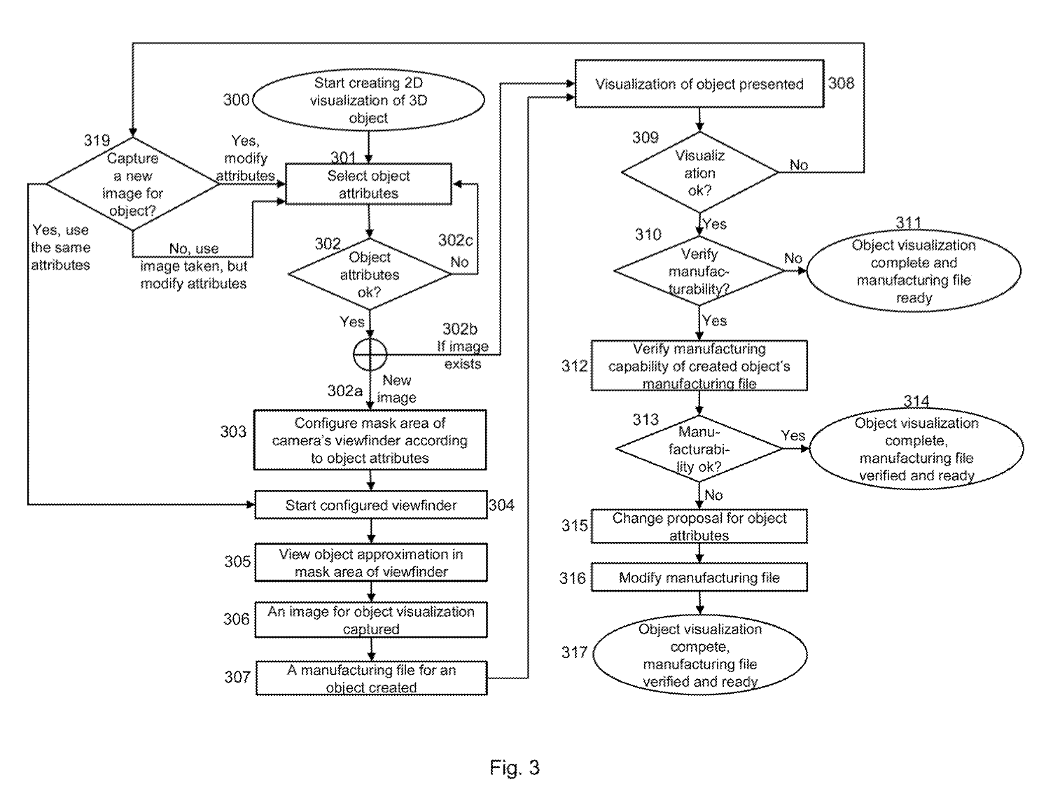

FIG. 3 shows another exemplary flow chart of method for design and visualization of a physical object with options to modify the visualization of the physical object being modeled, to verify the manufacturing readiness against manufacturing parameters and to change the selected set of attributes for the physical object being modeled and change the image data to which the modeling of object is based on. In this advantageous embodiment of the invention, the process for creating a design and visualization of a physical object starts in step 300 in which a user starts the application user interface 104 on a suitable apparatus with integrated camera 10.

In step 301 a selection of available object attributes for the physical object being modeled is provided on the application user interface 104. Advantageously, the selection of attributes for the physical object being modelled may comprise at least one of the following: a shape of the object, dimensions of the object comprising at least one of the following: height, width, and length, texture, colour, a material of object and a method of manufacturing of the object. The user selects the attributes for the physical object being modelled through the application user interface 104. The selection of attributes for the physical object being modelled can be pre-defined. Advantageously, the selection of attributes for the physical object being modelled can be defined by the user. For example, the size of the object can be based on its real size on 1:1 scale. Also, the size of the object can be defined by the user. The selection of attributes for the physical object being modelled can also comprise both pre-defined and user-defined attributes.

In step 302 the user confirms the selected set of object attributes for the physical object being modeled to be ready for proceeding or, alternatively, notifies need for changes on the application user interface 104 by the request from computer program code 1031. The user may still change the selected set of object attributes for the physical object being modeled on the application user interface 104, in which case step 301 is repeated according to step 302c. If the selected set of object attributes for the physical object being modeled is ready step 302a or step 302c is selected by the user on the application user interface. Step 302c will be explained later in the description in connection with step 319.

According to step 302b the user confirms that the selected set of object attributes for the physical object being modeled is ready on the application user interface 104. The user wishes to capture a new image for modeling the physical object according to the selected set of object attributes. In this case step 303 is taken according to the method.

In step 303 the set of selected attributes for the physical object being modelled are applied in configuring the mask area of the viewfinder of the camera component 1051b. During step 303 the computer program code for design and visualization of the physical object 1031 accesses the camera component 105 through the camera interface 1051. The computer program code for design and visualization of the physical object 1031 implements the configured mask area of the viewfinder 1041a on the application user interface 104 by modifying the viewfinder of the camera component 1051b according to the set of selected attributes for the physical object being modelled. Advantageously, the computer program code 1031 modifies a viewfinder of a camera component 1051b according to at least one of the following: data from the camera module and a selected set of object attributes for the physical object being modeled. The configured viewfinder 1041 with the now configured mask area of the viewfinder 1041a is started on the application user interface 104. The outlying area of the viewfinder 1041b displays regular viewfinder feed coming from the camera viewfinder 1051b. In other words, visually the outlying area of the viewfinder 1041b appears as a regular view in any camera viewfinder.

In step 304 the configured mask area of the viewfinder 1041a is running on the application user interface 104. The configured mask area of the viewfinder 1041a advantageously displays an approximation of the physical object being modeled on the application user interface 104 while the user may search an image to be captured for creating the model for the physical object. The configured mask area of the viewfinder 1041a displays an effected visual feed of image data based on the defined approximation attributes, which mean the selected set of attributes for the physical object being modeled. The configured mask area of the viewfinder 1041a on the application user interface 104 approximates the physical object being modeled according to its selected set of attributes.

During step 305 an approximation for the physical object being created is shown in the mask area of the configured viewfinder 1041a on the application user interface 104. Advantageously, the visual transition from the outlying area of the viewfinder 1041b to the configured mask area of the viewfinder 1041a is seamless while the user shifts the viewfinder 1041 from one angle of view to another one. What the user sees in the configured mask area of the viewfinder 1041a on the application user interface 104 is a real-time simulation of what the physical object being modeled would look like with the image content that is inside the mask area of the viewfinder 1041a. What the user sees in the configured mask area of the viewfinder 1041a on the application user interface 104 is a semi-finalized simulation of the physical object being modeled with the image content that is inside mask area of the viewfinder 1041a. Also, what the user sees in the configured mask area of the viewfinder 1041a on the application user interface 104 is a real-time simulation of the physical object being modeled with the image content that is inside mask area of the viewfinder 1041a. The image content that is inside the configured mask area of the viewfinder 1041a is also effected by the selected set of attributes for the physical object being modeled. Further, visual data, the visual feed, coming from the camera component 105 and inside the configured mask area of the viewfinder 1041a can be heavily effected and, for example, a kaleidoscope type of effect can be applied. Also, a visual element can be copied to effect the visual data coming from the camera component 105, for example. This means applying effects to the visual feed from the camera component regardless of other the selected set of attributes for the physical object being modeled that modifies the image data in the inside the configured mask area of the viewfinder 1041a. The visual data from the camera component 105 can also be effected prior to embedding it into a design of the physical object being modeled with effecting based on aesthetic values. This effecting can also extend to the outlying of the viewfinder 1041b.

Advantageously, the computer program code 1031 may comprise defining the selected set of object attributes also while viewing an approximation of the physical object being modelled in the mask area of the configured viewfinder 1041a is active on the application user interface 104 in step 305. In that case the mask area of the configured viewfinder 1041a is reconfigured according to at least one of the following: data apparent in the mask area of the configured viewfinder 1041a on the application user interface 104 and the set of selected object attributes. Therefore, the selected set of object attributes according to step 301 is changed and the changed set of object attributes will be applied in later phases of the method. The changed set of object attributes may comprise attributes defined by data apparent in the mask area of the configured viewfinder 1041a while the selected set of object attributes is being redefined. While the configured mask area of the viewfinder 1041b is active, an approximation of the physical object being modelled is advantageously presented in the mask area on the application user interface from one angle of view at a time.

At least one image for creating a visualization of the physical object being modeled is captured in step 306 by the user. Advantageously, the captured image is a regular 2D image. More advantageously, the visual data for the image can also be based on multiple layers of visual data coming from multiple images. Pressing the shutter button of the used apparatus with integrated camera 10 captures the image data as visualized within the configured mask area of the viewfinder 1041a. The image is captured and stored according to the implementation of the camera component present in the used apparatus 10 in which the application user interface 104 is running.

A manufacturing file for the physical being modeled is created in step 307 by the computer program code 1031. The manufacturing file comprises the set of selected attributes for the physical object being modeled together with the image data for physical object captured in step 306. While constructing the manufacturing file the captured image is embedded to the design of the physical object modeled. Advantageously, embedding the captured image to the design of the physical object modeled is defined by the selected set of attributes for the physical object modeled. The manufacturing file is stored in a suitable area of the memory 103. The manufacturing file is a 3D file. Advantageously, the manufacturing file is a standard 3D file. The manufacturing file is a standard 3D file suitable for producing the physical object with various devices and systems recognizing such file.

A visualization for the physical object being modeled is presented on the application user interface 104 according to step 308. The visualization for the physical object being modeled is created by the computer program code 1031 according to the manufacturing file. Advantageously, the visualization of the physical object being modelled is a presentation of the physical object as it would look like when manufactured on the basis of the one or more captured image and the selected set of attributes for the object. The visualization of the physical object being modelled is a presentation of the physical object as it would appear when manufactured according to the created manufacturing file. More advantageously, the visualization of the physical object being modelled is a 3D visualization. The 3D visualization may be created by viewing the physical object being modelled on the basis of 2D images from one angle of view at a time.

In step 309 confirming the acceptability of the visualization for the physical object being modeled is requested by the computer program code 1031 on the application user interface 104.

According to step 309 if the visualization for the physical object being modeled is acceptable by the user, step 310 is taken. If the visualization for the physical object being modeled is not acceptable by the user, step 319 is taken.

If the visualization for the physical object being modeled is not acceptable by the user according to step 309, step 319 is taken. In step 319 the computer program code 1031 requests from the user on the application user interface 104, if the user wishes to capture at least one new image for the physical object being modeled. Advantageously, the user may choose to capture a new image and also modify the selected set of attributes for the physical object being modeled, in which case the previously described step 301 is taken and the process continues from there as described above in connection with step 301. The user may choose to capture a new image and also modify the selected set of attributes for the physical object being modeled, in which case the previously described step 301 is taken by the computer program code 1031 and the process continues from there as described in connection with step 301. Also advantageously, the user may choose to capture a new image but keep the previously selected set of attributes for the physical object being modeled, in which case the previously described step 304 is taken by the computer program code 1031 and the process continues from there as described above.

During step 319 the user may also advantageously choose to keep the at least one already captured image but modify the selected set of attributes for the physical object being modeled. In that case the previously described step 301 is taken by the computer program code 1031 to allow the user to change the previously selected set of attributes for the physical object being modeled. After the user has selected a new set of attributes for the physical object being modeled in step 301 on the application user interface 104, step 302 is taken by the computer program code 1031. In step 302 the computer program code 1031 requests the user to confirm the selected set of attributes for the physical object being modeled on the application user interface 104. The user could still choose to capture a new image for the physical object being modeled according to the previously described step 302b or still change the attributes for the physical being modeled according to step 302c. Advantageously, the user is now allowed to choose also step 302b by the computer program code 1031, because the previously captured image has not been changed. According to step 302b the changed set of attributes for the physical object being modeled is now applied to visualization of the physical object on the basis of the not changed image for the physical object. The computer program code 1031 creates a visualization for the physical object being modeled in step 308 according to the already existing image and the changed set of attributes for the physical object being modeled.

If the user confirms that the visualization for the physical object being modeled is ready in step 309, then the user is requested by the computer program code 1031 on the application user interface 104 to choose if the user wants to verify that the physical object being modeled can be manufactured according to the previously created manufacturing file for the physical object in step 310. If the user does not wish to verify the manufacturability of the physical object being modeled according to its manufacturing file, step 311 is taken by the computer program code 1031 and the process is complete. In step 311 the manufacturing file for the physical object is ready in accordance with step 307. Advantageously, on the application user interface 104, there may be an option to retrieve the manufacturing file from the memory 103, provided by the computer program code 1031, for example. Also, on the application user interface 104, there may be an option to order a product according to the manufacturing file provided by the computer program code 1031, for example.

If the user chooses to verify the manufacturability of the physical object being modeled according to its manufacturing file in step 310, step 312 is taken by the computer program code 1031. In step 312 the computer program code 1031 compares the known parameters of the selected manufacturing method according to the set of selected attributes for the physical object being modeled against the model of the physical object according to its manufacturing file created in step 307. The computer program code 1031 analyses if the physical object according to the manufacturing file can be manufactured with the chosen manufacturing method and what is known from that method. If no manufacturing method is included in the set of selected attributes for the physical object being modeled, the user may be advantageously requested by the computer program code 1031 on the application user interface 104 to select a manufacturing for the object so that verification can be performed by the computer program code 1031. Advantageously, the computer program code 1031 may also perform a strength calculation for the physical object being modelled on the basis of the manufacturing file to further verify the manufacturing capability of the object and its durability in its intended use.

If the result of verification of the manufacturability for the physical object being modeled is positive in step 313, step 314 is taken. This means that the physical object being modeled can be manufactured according to its manufacturing file. Step 314 is taken by the computer program code 1031 and the process is complete. In step 314 the manufacturing file for the physical object is ready in accordance with step 307. Advantageously, on the application user interface 104, there may be options to retrieve the manufacturing file from the memory 103 or to order a product according to the manufacturing file, for example, provided by the computer program code 1031.

If the result of verification of the manufacturability for the physical object being modeled is negative in step 313, step 315 is taken. This means that the physical object being modeled cannot be manufactured according to its manufacturing file on the basis of the analysis run by the computer program code 1031. The computer program code 1031 may suggest on the application user interface 104 changes to the selected set of attributes for the physical object being modeled in order to make the physical object suitable for manufacturing. The computer program code 1031 may suggest on the application user interface 104 changing the selected method of manufacturing to another method of manufacturing, for example. This would be a possible option, if the physical object being modeled could be manufactured by another manufacturing method. Alternatively, the computer program code 1031 may suggest on the application user interface 104 changing other attributes currently included in the selected set of attributes for the physical object being modeled such as dimensions or texture, for example. The computer program code 1031 may also visualize on the application user interface 104 the suggested changes to the physical object. This visualization shows in a presentation of how the physical object would appear with the proposed changes accepted.

According to step 316 the manufacturing of the physical object being modeled is modified by the computer program code 1031 in accordance with accepted set of changes to the manufacturing file. The user may be provided an option to decline the proposed changes as well. Further, the computer program code 1031 may allow on the application user interface 104 the user to suggest changes to the attributes of the physical object.

Step 317 is taken by the computer program code 1031 and the process is complete. In step 317 the manufacturing file for the physical object being modelled is ready in accordance with steps 315 and 316. Advantageously, on the application user interface 104, there may be options to retrieve the manufacturing file from the memory 103 or to order a product according to the manufacturing file, for example, provided by the computer program code 1031.

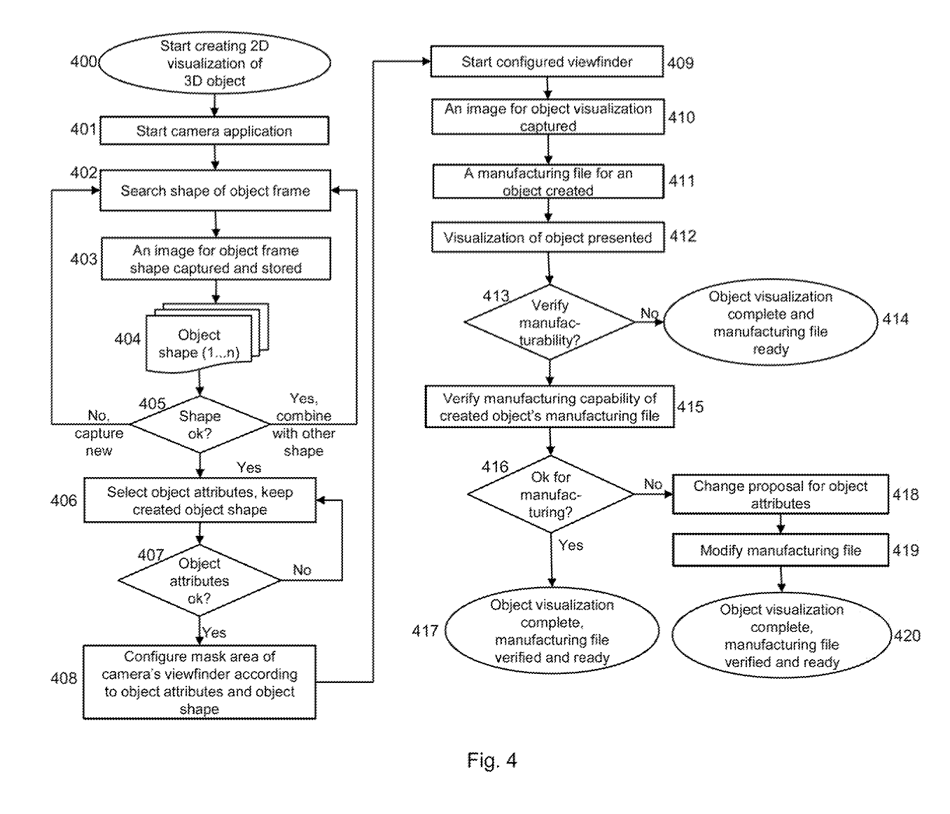

FIG. 4 shows another exemplary flow chart of a method for design and visualization of a physical object with capability to define a shape for the physical object being modeled on the basis of an image captured by the user, to verify the manufacturing against manufacturing parameters and change the selected set of attributes for the physical object being modeled and change the image data which the modeling of object is based on. In this advantageous embodiment of the invention, the process for creating a design and visualization of a physical object starts in step 400 in which a user starts the application user interface 104 on a suitable apparatus with integrated camera 10.

In step 401 the computer program code 1031 enables the user on the application user interface 104 to select creating a shape for the physical object being modeled on the basis of an image captured by the user for the shape of the object. Advantageously, the camera application of the camera component 105 is started by the computer program code 1031 on the application user interface for capturing the image for the shape of the object. The user searches the shape of the object with the viewfinder of the camera component 1051b in step 402. The visual feed on the viewfinder of the camera component 1051b running on the application user interface is a regular visual feed for the viewfinder of the camera component 1051b. The computer program code 1031 may alter the viewfinder of the camera component 1051b for enabling more efficient capturing of a shape suitable for a physical object.

Advantageously, in step 402, the computer program code 1031 may enable defining a selected set of object attributes while the viewfinder of the camera component 1051b is active on the application user interface 104. Then the mask area of the viewfinder of the camera component 1051b is reconfigured according to at least one of the following: the data apparent in the viewfinder on the application user interface and the defined set of selected object attributes. Thus, the selected set of object attributes is defined already in step 402. That selected set of object attributes of step 402 will be applied in later phases of the method unless changed in later steps of the method. The selected set of object attributes of step 402 may comprise attributes defined by the data apparent in the mask area of the viewfinder of the camera component 1051b.

In step 403 the user captures at least one image for creating the object shape. The at least one image for the object shape is stored by the computer program code 1031 to a suitable area of memory 103. The shape of the object is constructed by the computer program code 1031 on the basis of one or more images for the object shape in step 404.

In step 405 the computer program code 1031 visualizes the object shape on the application user interface 104. The computer program code 1031 requests the user to accept or decline the object shape. The user may decline the shape and capture at least one new image for the shape in which case the computer program code 1031 returns to step 402. The user may also confirm that the presented object shape is acceptable but the user wishes to combine it with another shape. In that case the computer program code 1031 returns to step 402 and allows the user to capture at least one more image for the object shape. If the user considers the object shape acceptable as such, step 406 is taken by computer program code 1031.

In step 406 a selection of available object attributes for the physical object being modeled are provided on the application user interface 104. Advantageously, the selection of attributes for the physical object being modelled may comprise at least one of the following: a shape of the object, dimensions of the object comprising at least one of the following: height, width, and length, texture, colour, a material of object and a method of manufacturing of the object. The user selects the attributes for the physical object being modelled in step 406 through the application user interface 104 but the shape of the object is defined according to step 404 by the computer program code 1031. The selection of attributes for the physical object being modelled can be pre-defined by the computer program code 1031. Advantageously, the selection of attributes for the physical object being modelled can be defined by the user on the application user interface 104. For example, the size of the object can be based on its real size on 1:1 scale or it can be defined by the user. The selection of attributes for the physical object being modelled can also comprise both pre-defined and user-defined attributes.

In step 407 the user confirms the selected set of object attributes for the physical object being modeled to be ready for proceeding or, alternatively, notifies need for changes on the application user interface 104 by the request from computer program code 1031. The user may still change the selected set of object attributes for the physical object being modeled on the application user interface 104, in which case step 406 is repeated. If the selected set of object attributes for the physical object being modeled is accepted by the user, step 408 is taken by the computer program code 1031.

In step 408 the set of selected attributes for the physical object being modelled are applied in configuring the mask area of the viewfinder of the camera component 1051b. During step 408 the computer program code for design and visualization of the physical object 1031 accesses the camera component 105 through the camera interface 1051. The computer program code for design and visualization of the physical object 1031 implements the configured mask area of the viewfinder 1041a on the application user interface 104 by modifying the viewfinder of the camera component 1051b according to the set of selected attributes for the physical object being modelled. Advantageously, while the configured mask area of the viewfinder 1041a is active, an approximation of the physical object being modelled is presented in the mask area 1041a on the application user interface 104 from one angle of view at a time. The configured viewfinder 1041 with the now configured mask area of the viewfinder 1041a is started on the application user interface 104. The configured mask area of the viewfinder 1041a visible on the application user interface 104 has the shape of the object according to the created shape of step 404. The outlying area of the viewfinder 1041b displays regular viewfinder feed coming from the camera viewfinder 1051b. In other words, visually the outlying area of the viewfinder 1041b appears as a regular view in any camera viewfinder.

In step 409 the configured mask area of the viewfinder 1041a is running on the application user interface 104. The configured mask area of the viewfinder 1041a advantageously displays an approximation of the physical object being modeled on the application user interface 104 while the user may search an image to be captured for creating the model for the physical object. The configured mask area of the viewfinder 1041a displays an effected visual feed of image data based on the defined approximation attributes, which mean the selected set of attributes for the physical object being modeled. The configured mask area of the viewfinder 1041a on the application user interface 104 approximates the physical object being modeled according to its selected set of attributes. Advantageously, the visual transition from the outlying area of the viewfinder 1041b to the configured mask area of the viewfinder 1041a is seamless while the user shifts the viewfinder 1041 from one angle of view to another one. What the user sees in the configured mask area of the viewfinder 1041a on the application user interface 104 is a real-time simulation of what the physical object being modeled would look like with the image content that is inside mask area of the viewfinder 1041a. What the user sees in the configured mask area of the viewfinder 1041a on the application user interface 104 is a semi-finalized simulation of the physical object being modeled with the image content that is inside mask area of the viewfinder 1041a.

The image content that is inside the configured mask area of the viewfinder 1041a is also effected by the selected set of attributes for the physical object being modeled. Further, visual data, the visual feed, coming from the camera component 105 and inside the configured mask area of the viewfinder 1041a can be heavily effected and, for example, a kaleidoscope type of effect can be applied. Also, a visual element can be copied to effect the visual data coming from the camera component 105, for example. This means applying effects to the visual feed from the camera component regardless of other the selected set of attributes for the physical object being modeled that modifies the image data in the inside of the configured mask area of the viewfinder 1041a. The visual data from the camera component 105 can also be effected prior to embedding it into a design of the physical object being modeled with effecting based on aesthetic values. This effecting can also extend to the outlying of the viewfinder 1041b.

At least one image for creating a visualization of the physical object being modeled is captured in step 410 by the user. Advantageously, the captured image is a regular 2D image. More advantageously, the visual data for the image can also be based on multiple layers of visual data coming from multiple images. Pressing the shutter button of the used apparatus with integrated camera 10 captures the image data as visualized within the configured mask area of the viewfinder 1041a having the object shape according to step 404. The image is captured and stored according to the implementation of the camera component present in the used apparatus 10 in which the application user interface 104 is running.

A manufacturing file for the physical object being modeled is created in step 411 by the computer program code 1031. The manufacturing file comprises the set of selected attributes for the physical object being modeled together with the image data for physical object captured in step 410. The set of selected attributes for the physical object being modeled includes the object shape, which is defined according to step 404. While constructing the manufacturing file the captured image is embedded to the design of the physical object modeled. Advantageously, embedding the captured image to the design of the physical object modeled is defined by the selected set of attributes for the physical object modeled. The manufacturing file is stored in a suitable area of the memory 103. Advantageously, the manufacturing file is a standard 3D file. The manufacturing file is a standard 3D file suitable for producing the physical with various devices and systems recognizing such a file.

A visualization for the physical object being modeled is presented on the application user interface 104 according to step 412. The visualization for the physical object being modeled is created by the computer program code 1031 according to the manufacturing file. Advantageously, the visualization of the physical object being modelled is a presentation of the physical object as it would look like when manufactured on the basis of the one or more captured image and the selected set of attributes for the object. The visualization of the physical object being modelled is a presentation of the physical object as it would appear when manufactured according to the created manufacturing file. More advantageously, the visualization of the physical object being modelled is a 3D visualization. The 3D visualization may be created by viewing the physical object being modelled on the basis of 2D images from one angle of view at a time.

In step 415 the computer program code 1031 verifies if the physical object being modeled can be manufactured according to its selected set of attributes for the physical object. The computer program code 1031 compares the known parameters of the selected manufacturing method according to the set of selected attributes for the physical object being modeled against with the model of the physical object according to its manufacturing file created in step 411. The computer program code 1031 analyses if the physical object according to the manufacturing file can be manufactured with the chosen manufacturing method and what is known from that method. If no manufacturing method is included in the set of selected attributes for the physical object being modeled, the user may be advantageously requested by the computer program code 1031 on the application user interface 104 to select a manufacturing for the object so that verification can be performed by the computer program code 1031. Advantageously, the computer program code 1031 may also perform a strength calculation for the physical object being modelled on the basis of the manufacturing file to further verify the manufacturing capability of the object and its durability in its intended use.

If the result of verification of the manufacturability for the physical object being modeled is positive in step 416, step 417 is taken. This means that the physical object being modeled can be manufactured according to its manufacturing file. Step 417 is taken by the computer program code 1031 and the process is complete. In step 314 the manufacturing file for the physical object is ready in accordance with step 411. Advantageously, on the application user interface 104, there may be options to retrieve the manufacturing file from the memory 103 or to order a product according to the manufacturing file, for example, provided by the computer program code 1031.

If the result of verification of the manufacturability for the physical object being modeled is negative in step 417, step 418 is taken. This means that the physical object being modeled cannot be manufactured according to its manufacturing file on the basis of the analysis run by the computer program code 1031. The computer program code 1031 may suggest on the application user interface 104 changes to the selected set of attributes for the physical object being modeled in order to make the physical object suitable for manufacturing. The computer program code 1031 may suggest on the application user interface 104 changing the selected method of manufacturing to another method of manufacturing, for example. This would a possible option, if the physical object being modeled could be manufactured by another manufacturing method. Alternatively, the computer program code 1031 may suggest on the application user interface 104 changing other attributes currently included in the selected set of attributes for the physical object being modeled such as dimensions or texture, for example. The computer program code 1031 may also visualize on the application user interface 104 the suggested changes to the physical object. This visualization shows in a concrete presentation how the physical object would appear with the proposed changes accepted.

According to step 419 the manufacturing of the physical object being modeled is modified by the computer program code 1031 in accordance with accepted set of changes to the manufacturing file. The user may be provided an option to decline the proposed changes as well. Further, the computer program code 1031 may allow on the application user interface 104 the user to suggest changes to the attributes of the physical object.

Step 420 is taken by the computer program code 1031 and the process is complete. In step 420 the manufacturing file for the physical object being modelled is ready in accordance with steps 418 and 419. Advantageously, on the application user interface 104, there may be options to retrieve the manufacturing file from the memory 103 or to order a product according to the manufacturing file, for example, provided by the computer program code 1031.

Any of the steps described or illustrated herein may be implemented using executable instructions in a general-purpose or special-purpose processor and stored on a computer-readable storage medium (e.g., disk, memory, or the like) to be executed by such a processor. References to ‘computer-readable storage medium’ and ‘computer’ should be understood to encompass specialized circuits such as field-programmable gate arrays, application-specific integrated circuits (ASICs). USB flash drives, signal processing devices, and other devices.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for design and visualization of a physical object, the method comprising:
providing a selection of object attributes for the physical object being modelled on an application user interface;
configuring a mask area of a viewfinder of a camera component to the application user interface according to a selected set of object attributes for the physical object being modelled;
viewing an approximation of the physical object being modelled in the mask area of the configured viewfinder on the application user interface according to the selected set of object attributes;
constructing at least one manufacturing file for the physical object being modelled after at least one image for the physical object being modelled is being captured; and
visualizing the physical object being modelled on the application user interface.

2. The method according to claim 1 wherein the selected set of object attributes for the physical object comprises at least one of following: shape, dimensions, material, texture and method of manufacturing.

3. The method according to claim 1 wherein viewing an approximation of the physical object being modelled in the mask area of the configured viewfinder on the application user interface is accomplished by rendering the image data apparent in the mask area of the configured viewfinder by the selected set of object attributes for the physical object being modelled.

4. The method according to claim 1 wherein a shape of the mask area in the viewfinder visible on the application user interface is defined according to at least one of the following: the data apparent in the viewfinder on the application user interface and the defined set of selected object attributes.

5. The method according to claim 1 wherein visualization for the physical object being modelled is a 3D visualization.

6. The method according to claim 5 wherein visualization for the physical object being modelled is based on at least one captured 2D image for the physical object according to the view on the mask area of the configured viewfinder while image capturing and the set of selected object attributes for the physical object that are compiled together into the manufacturing file.

7. The method according to claim 6 wherein the manufacturing file for the physical object being modelled is verified for manufacturability according to the selection of object attributes for the physical object.

8. The method according to claim 2 wherein the selected set of object attributes is defined while viewing an approximation of the physical object being modelled in the mask area of the configured viewfinder is active on the application user interface and the mask area of the configured viewfinder is reconfigured according to at least one of the following: the data apparent in the viewfinder on the application user interface and the defined set of selected object attributes.

9. The method according to claim 2 wherein the selected set object attributes is defined while viewing the viewfinder of the camera component on the application user interface is active and the mask area of the viewfinder of the camera component is reconfigured according to at least one of the following: the data apparent in the viewfinder on the application user interface and the defined set of selected object attributes.

10. The method according to claim 3 wherein viewing an approximation of the physical object being modelled in the mask area of the configured viewfinder on the application user interface is accomplished by viewing the approximation of the physical object being modelled from one angle of view at a time.

11. A non-transitory computer readable storage medium having computer-executable components for design and visualization of a physical object comprising:
a computer readable code for providing a selection of object attributes for the physical object on an application user interface;
a computer readable code for configuring a mask area of a viewfinder of a camera component to the application user interface according to a selected set of object attributes for the physical object being modelled;
a computer readable code for viewing an approximation of the physical object being modelled in the mask area of the configured viewfinder on the application user interface according to the selected set of object attributes;
a computer readable code for constructing at least one manufacturing file for the physical object being modelled after at least one image for the physical object being modelled is being captured; and
a computer readable code for visualizing the physical object being modelled on the application user interface.

12. The non-transitory computer readable storage medium having computer-executable components according to claim 11 further comprising a computer readable code for
rendering the view in the mask area of the configured viewfinder by the selected set of object attributes for the physical object being modelled for accomplishing the viewing an approximation of the physical object being modelled from one angle of view at a time in the mask area of the configured viewfinder on the application user interface.

13. The non-transitory computer readable storage medium having computer-executable components according to claim 12 further comprising a computer readable code for visualizing the physical object being modelled on the basis of at least one captured 2D image for the physical object according to the view on the mask area of the configured viewfinder while image capturing and the selection of object attributes for the physical object that are compiled together into the manufacturing file.

14. The non-transitory computer readable storage medium having computer-executable components according to claim 13 further comprising a computer readable code for verifying the manufacturability of the manufacturing file for the physical object being modelled according to the selection of object attributes for the physical object.

15. The non-transitory computer readable storage medium having computer-executable components according to claim 11 further comprising a computer readable code for
defining the selected set of object attributes while viewing an approximation of the physical object being modelled in the mask area of the configured viewfinder is active on the application user interface; and
reconfiguring the mask area of the configured viewfinder according to at least one of the following: the data apparent in the viewfinder on the application user interface and the defined set of selected object attributes.

16. The non-transitory computer readable storage medium having computer-executable components according to claim 11 further comprising a computer readable code for
defining the selected set of object attributes while viewing the viewfinder of the camera component on the application user interface is active on the application user interface; and
reconfiguring the mask area of the viewfinder of the camera component on the application user interface according to at least one of the following: the data apparent in the viewfinder on the application user interface and the defined set of selected object attributes.

17. An apparatus with integrated camera, the apparatus comprising:
a data communication interface;
a one or more processors;
a one or more memories including a computer program code;
a camera component including a camera interface and a viewfinder;
an application user interface; and
the one or more memories and the computer program code configured to, with the one or more processors, cause the apparatus at least to
receive one or more object attributes for a physical object being modelled from an application user interface;
configure a mask area of the viewfinder of the camera component by the one or more object attributes for the physical object being modelled; and
run the viewfinder with the mask area configured according to the one or more object attributes on the application user interface for viewing an approximation of a physical object being modelled.

18. The apparatus with integrated camera according to claim 17 wherein the configured mask area of the viewfinder running on the application user interface is reconfigured according to at least one of the following: the data apparent in the viewfinder on the application user interface and the defined set of selected object attributes.

19. The apparatus with integrated camera according to claim 17 wherein the mask area of the viewfinder of the camera component is configured on the application user interface according to at least one of the following: the data apparent in the viewfinder on the application user interface and the defined set of selected object attributes.

20. The apparatus with integrated camera according to claim 17 wherein a shape of the mask area in the viewfinder on the application user interface is defined according to at least one of the following: the data apparent in the viewfinder on the application user interface and the defined set of selected object attributes.
